(19) United States
(12) Patent Application Publication
(10) Pub. No.: US 2019/0022658 A1
(43) Pub. Date: Jan. 24, 2019

(54) GENE MEASUREMENT APPARATUS

(71) Applicant: SHIMADZU CORPORATION, Kyoto-shi (JP)

(72) Inventors: Kenji NINOMIYA, Kyoto-shi (JP); Masamitsu SHIKATA, Kyoto-shi (JP); Naoko TAKAOKA, Kyoto-shi (JP); Shinichiro KOBAYASHI, Kyoto-shi (JP)

(73) Assignee: SHIMADZU CORPORATION, Kyoto-shi (JP)

(21) Appl. No.: 16/040,966

(22) Filed: Jul. 20, 2018

(30) Foreign Application Priority Data
Jul. 21, 2017 (JP) 2017-141753

(51) Int. Cl. B01L 7/00

(52) U.S. Cl. CPC B01L 7/52; B01L 2300/025; B01L 2300/18

(57) ABSTRACT

A gene measurement apparatus includes: a temperature control block that is provided with, on its upper surface, a plurality of reaction vessel wells each being used to house a reaction vessel, and that performs temperature treatment on a specimen in the reaction vessel by controlling temperature of the plurality of reaction vessel wells using a heating element or a cooling element; and a reaction vessel detector configured to detect whether the reaction vessel is housed in each of the plurality of reaction vessel wells of the temperature control block before the temperature treatment is started.

### BACKGROUND OF THE INVENTION

### 1. Field of the Invention

The present invention relates to a gene measurement apparatus that performs temperature treatment for repeating the heating and cooling down of a reaction vessel that houses a specimen including genes and a reaction reagent so as to amplify a specified gene in the specimen and that measures the specimen during the treatment.

### 2. Description of the Related Art

A gene measurement apparatus has been proposed that includes a temperature control block that is configured to house a plurality of reaction vessels (see, for example, Patent Document 1). A plurality of reaction vessel wells that respectively house reaction vessels are provided on an upper surface of the temperature control block. Temperature treatment for repeating heating and cooling down by using a heater, a Peltier element, or the like is performed on the respective reaction vessels housed in the plurality of reaction vessel wells of the temperature control block.

Examples of reaction vessels used in the gene measurement apparatus include individual reaction vessels, a plurality of reaction vessels (for example, 8 reaction vessels) that are continued in a line, and a plate-shape reaction vessel (referred to as a well plate) in which a plurality of wells that each house a specimen are provided so as to correspond to the arrangement of the reaction vessel wells of the temperature control block.

When the individual reaction vessels or the plurality of reaction vessels that are continued in a line are used, some of the reaction vessel wells provided in the temperature control block may be used. In this case, a user can install the individual reaction vessels or the plurality of reaction vessels that are continued in a line in arbitrary reaction vessel wells of the temperature control block.

The gene measurement apparatus includes an optical sensor that optically measures a specimen in a reaction vessel during temperature treatment, and can perform various types of analysis using the measurement results. Examples of analysis include absolute quantitative analysis for determining the concentration of a measured specimen, relative quantitative analysis for determining a relative expression amount with respect to a gene, and SNP analysis for determining a genotype.

A user designates the position of a reaction vessel well in which a specimen in a reaction vessel will be housed, sets, for example, analysis to be performed on the reaction vessel well as measurement conditions, and houses a target reaction vessel in a reaction vessel well that is located in the designated position. Alternatively, a user first installs a target reaction vessel in a reaction vessel well located in an arbitrary position, and sets measurement conditions for the reaction vessel well in which the reaction vessel has been installed.

By inputting a command to start measurement to the apparatus, gene amplification treatment and measurement under the set measurement conditions are automatically performed on the specimen in the reaction vessel, and an analysis result obtained in the measurement is presented to the user.

### PRIOR ART DOCUMENT

### Patent Document

Patent Document 1: JP 2016-095315 A

### SUMMARY OF THE INVENTION

As described above, in measurement using a gene measurement apparatus, a user performs tasks such as the designation of a reaction vessel well in which a reaction vessel will be housed, the setting of measurement conditions for the reaction vessel well, or the housing of the reaction vessel in the reaction vessel well. However, a large number of reaction vessel wells, such as 48 reaction vessel wells or 96 reaction vessel wells, are provided in a temperature control block. Therefore, there may occur a situation in which a user mistakenly houses a reaction vessel in a reaction vessel well located in a position that is different from the position of a reaction vessel well for which measurement conditions have been set or a situation in which a user mistakenly sets measurement conditions for a reaction vessel well located in a position that is different from the position of a reaction vessel well in which a reaction vessel is actually housed.

Even when the situation described above occurs, since the apparatus performs analysis under measurement conditions that have been set for a reaction vessel well located in a position designated by the user, a desired analysis result fails to be obtained for a specimen in a reaction vessel that is housed in an incorrect reaction vessel well.

A conventional gene measurement apparatus is not configured to recognize the position of a reaction vessel well in which a user has actually housed a reaction vessel. Therefore, even when a user houses a reaction vessel in an incorrect position, this error is not recognized, and a situation occurs where the user does not notice the error until the user checks an analysis result obtained in measurement.

Accordingly, it is an object of the present invention to enable the recognition of the position of a reaction vessel well in which a reaction vessel is housed.

A gene measurement apparatus according to the present invention includes: a temperature control block that is provided with a plurality of reaction vessel wells on an upper surface of the temperature control block, each of the plurality of reaction vessel wells being used to house a reaction vessel, and that performs temperature treatment on a specimen in the reaction vessel by controlling temperature of the plurality of reaction vessel wells using a heating element or a cooling element; and a reaction vessel detector configured to detect whether the reaction vessel is housed in each of the plurality of reaction vessel wells of the temperature control block before the temperature treatment is started.

In general, the gene measurement apparatus includes an optical sensor that performs optical detection on each of the plurality of reaction vessel wells. Accordingly, it is preferable that the reaction vessel detector be configured to determine whether the reaction vessel is housed in each of the plurality of reaction vessel wells in accordance with a detection signal of the optical sensor with respect to each of the plurality of reaction vessel wells. By doing this, a dedicated sensor that detects whether a reaction vessel is housed in a reaction vessel well does not need to be provided, and this enables an increase in a cost to be suppressed.

In a preferred embodiment, the gene measurement apparatus according to the present invention further includes: a display that displays information; and a reaction vessel housing position display configured to display, on the display, a position of a reaction vessel well in which the reaction vessel detector has detected that the reaction vessel is housed, before the temperature treatment is started. By doing this, before the temperature treatment is started, the position of a reaction vessel well in which a reaction vessel is housed is displayed on the display, and this enables a user to easily confirm a position in which the user has housed the reaction vessel before starting the measurement of a specimen. Here, the display is a liquid crystal display and the like that is provided in the gene measurement apparatus or that is electrically connected to the gene measurement apparatus.

The gene measurement apparatus includes a measurement conditions setting part configured to cause a user to set measurement conditions for an arbitrary reaction vessel well of the plurality of reaction vessel wells. According to the present invention, it is preferable that the gene measurement apparatus includes a reaction vessel position determination part that determines whether a position of the arbitrary reaction vessel well for which the measurement conditions have been set by the measurement conditions setting part matches the position of the reaction vessel well in which the reaction vessel detector has detected that the reaction vessel is housed, before the temperature treatment is started. By doing this, the apparatus can have a function of confirming whether a reaction vessel is correctly housed in a reaction vessel well for which measurement conditions have been set.

In this case, it is preferable that the reaction vessel position determination part be configured to issue a warning to the user, when the position of the arbitrary reaction vessel well for which the measurement conditions have been set by the measurement conditions setting part does not match the position of the reaction vessel well in which the reaction vessel detector has detected that the reaction vessel is housed. By doing this, even when the user mistakenly houses a reaction vessel in a reaction vessel well that is different from a reaction vessel well for which the measurement conditions have been set, the user can easily recognize this error. This prevents measurement from being started in a state where the position of a reaction vessel well for which measurement conditions have been set is different from the position of a reaction vessel well in which a reaction vessel is actually housed.

The gene measurement apparatus according to the present invention includes the reaction vessel detector configured to detect whether the reaction vessel is housed in each of the plurality of reaction vessel wells of the temperature control block before the temperature treatment is started. Thus, the position of each of the plurality of reaction vessel wells in which the reaction vessel is housed can be recognized in a stage before the temperature treatment is started.

### BRIEF DESCRIPTION OF THE DRAWINGS

FIG. 1 is a perspective view illustrating a temperature control block in an embodiment of a gene measurement apparatus together with reaction vessels;

FIG. 2 is a configuration diagram schematically illustrating a configuration in the embodiment;

FIG. 3 is a flowchart explaining an example of a flow before the measurement of a specimen in the gene measurement apparatus in the embodiment;

FIG. 4 illustrates an example of a setting screen of measurement conditions in the embodiment; and

FIG. 5 illustrates an example of a display screen of a reaction vessel housing position in the embodiment.

### DETAILED DESCRIPTION OF THE INVENTION

An embodiment of a gene measurement apparatus is described below with reference to the drawings.

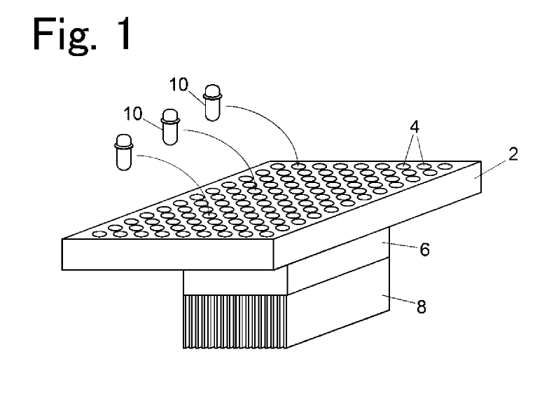

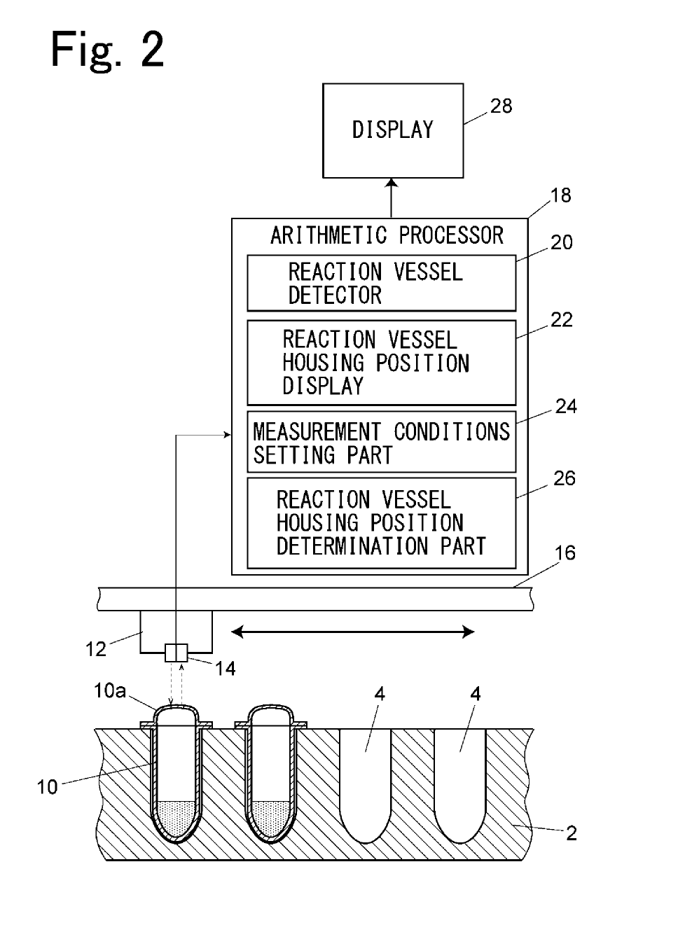

The configuration of the gene measurement apparatus in the embodiment is described with reference to FIGS. 1 and 2.

As illustrated in FIG. 1, the gene measurement apparatus includes a temperature control block 2 that is made of metal such as aluminum. A plurality of reaction vessel wells 4 are provided on an upper surface of the temperature control block 2. Each of the plurality of reaction vessel wells 4 is a recess that houses a body part of a reaction vessel 10 that houses a specimen to be measured. A Peltier element 6 is attached to the temperature control block 2. A heat radiation fin of the Peltier element 6 is denoted by the reference numeral 8.

Although not illustrated herein, in the gene measurement apparatus in the embodiment, a heat lid that is heated by a heater is provided above the temperature control block 2, and the heat lid presses lids 10a of the reaction vessels downward after the reaction vessels 10 are housed in the reaction vessel wells 4 of the temperature control block 2. The heat lid heats the lids 10a of the reaction vessels from above so as to prevent a reagent in each of the reaction vessels 10 from evaporating.

The gene measurement apparatus in the embodiment performs temperature treatment for increasing or decreasing the temperature of the reaction vessel 10 that is housed in each of the reaction vessel wells 4 to a prescribed temperature in accordance with a set temperature program by controlling an output of the Peltier element 6 attached to the temperature control block 2; optically measures the reaction of a specimen in each of the reaction vessels 10 during the treatment; and performs analysis.

As illustrated in FIG. 2, a measurement part 12 is provided above the temperature control block 2. The measurement part 12 is configured to move along a guide rail 16 on a horizontal plane above the temperature control block 2. The measurement part 12 includes an optical sensor 14. The optical sensor 14 is configured by a light source that emits light vertically downward, and a photodetector that receives light from below and detects the light.

During measurement, the measurement part 12 arranges the optical sensor 14 in a position immediately above each of the reaction vessel wells 4 of the temperature control block 2 so as to sequentially scan each of the reaction vessel wells 4, and optically measures the reaction of a specimen in a reaction vessel 10 that is housed in a corresponding reaction vessel well 4. A detection signal obtained by the optical sensor 14 is input to an arithmetic processor 18. The arithmetic processor 18 is implemented by a dedicated computer or a general-purpose personal computer.

The arithmetic processor 18 has a function of performing various types of analysis in accordance with the detection signal from the optical sensor 14. Examples of analysis performed by the arithmetic processor 18 include absolute quantitative analysis for determining the concentration of a measured specimen, relative quantitative analysis for determining a relative expression amount with respect to a gene, and SNP analysis for determining a genotype. A user can set analysis to be performed on a specimen to be measured as measurement conditions.

Although the heat lid described above is not illustrated in FIG. 2, the heat lid has an opening for measurement provided in a position immediately above each of the reaction vessel wells 4 in such a way that the optical sensor 14 can perform measurement.

Furthermore, the measurement part 12 may be provided below the temperature control block 2 so as to move on a horizontal plane. In this case, an opening for measurement is provided in the bottom of each of the reaction vessel wells 4 in such a way that the reaction of a specimen in a reaction vessel 10 that is housed in each of the reaction vessel wells 4 can be optically measured by the optical sensor 14 of the measurement part 12.

The arithmetic processor 18 includes a reaction vessel detector 20, a reaction vessel housing position display 22, a measurement conditions setting part 24, and a reaction vessel housing position determination part 26. The reaction vessel detector 20, the reaction vessel housing position display 22, the measurement conditions setting part 24, and the reaction vessel housing position determination part 26 are functions obtained by executing a prescribed program using an arithmetic element such as a CPU that is provided in the arithmetic processor 18.

The reaction vessel detector 20 is configured to detect whether the reaction vessel 10 is housed in each of the reaction vessel wells 4 of the temperature control block 2 at a prescribed timing after the measurement conditions described below have been set and all of the reaction vessels have been housed in the reaction vessel wells 4. Whether the reaction vessel 10 is housed in each of the reaction vessel wells 4 is determined using the optical sensor 14 of the measurement part 12. The measurement part 12 arranges the optical sensor 14 in a position immediately above each of the reaction vessel wells 4, and the optical sensor 14 emits excitation light (for example, a wavelength of 400 to 500 nm) vertically downward. When the reaction vessel 10 is housed in a target reaction vessel well 4, autofluorescence (for example, a wavelength of 510 to 600 nm) is emitted from the lid 10a of the reaction vessel 10, and the autofluorescence is detected by the optical sensor 14. By doing this, whether the reaction vessel 10 is housed in each of the reaction vessel wells 4 can be determined according to whether autofluorescence from the reaction vessel 10 is detected.

Further, when the measurement part 12 is provided below the temperature control block 2, excitation light is emitted vertically upward from a position immediately below each of the reaction vessel wells 4, and whether the reaction vessel 10 is housed in each of the reaction vessel wells 4 can be determined according to whether autofluorescence emitted from the bottom of the reaction vessel 10 is detected.

The reaction vessel housing position display 22 displays information relating to the position of each of the reaction vessel wells 4 in which the reaction vessel 10 is housed, on a display 28 that is electrically connected to the arithmetic processor 18, in accordance with the result of detection of the reaction vessel detector 20 in such a way that the position of each of the reaction vessel wells 4 in which the reaction vessel 10 is housed can be visually recognized. The display 28 is implemented by a liquid crystal display or the like.

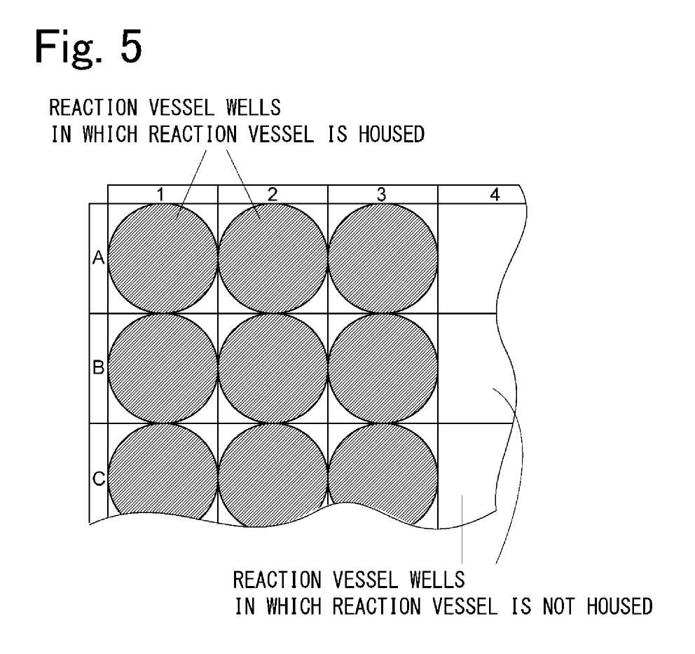

Examples of the information relating to the position of each of the reaction vessel wells 4 in which the reaction vessel 10 is housed include a map in which all or some of the reaction vessel wells 4 are drawn planarly, as illustrated in FIG. 5. In the map illustrated in FIG. 5, reaction vessel wells 4 in which the reaction vessel 10 is housed and reaction vessel wells 4 in which the reaction vessel 10 is not housed are indicated so as to be visually distinguishable from each other.

The measurement conditions setting part 24 is configured to set measurement conditions for each specimen in the reaction vessel 10 and measurement conditions that are common to all of the specimens in accordance with information input from a user. Examples of the measurement conditions for each of the specimens include the position of a reaction vessel well 4 to be used in the measurement of a target specimen and the type of a fluorescent material to be measured. Examples of the measurement conditions that are common to all of the specimens include the conditions of temperature treatment (reaction conditions) and an item of analysis to be performed according to detected light. From among the measurement conditions, the measurement conditions for each of the specimens (such as the position of the reaction vessel well 4 to be used in the measurement of a target specimen or the type of a fluorescent material to be measured) are set for the reaction vessel well 4.

Stated another way, the measurement conditions setting part 24 causes a user to input measurement conditions for each of the specimens to be measured and measurement conditions that are common to all of the specimens. The measurement conditions setting part 24 sets the measurement conditions input by the user.

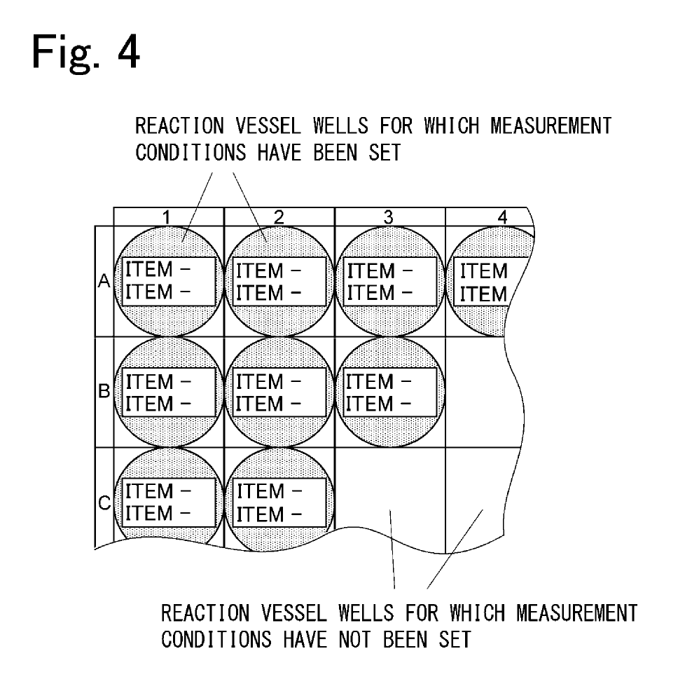

It is preferable that, when setting the measurement conditions, the measurement conditions setting part 24 displays a map indicating all of the reaction vessel wells 4 on the display 28, and causes a user to designate, on the map, a reaction vessel well 4 for which the measurement conditions will be set. It is also preferable that, on a map in which all or some of the reaction vessel wells 4 are drawn planarly, reaction vessel wells 4 for which the measurement conditions have been set be indicated so as to be visually distinguishable from reaction vessel wells 4 for which the measurement conditions have not been set, as illustrated in FIG. 4.

The reaction vessel housing position determination part 26 is configured to compare, after the reaction vessel detector 20 completes the confirmation of the housing positions of the reaction vessels 10, the position of each of the reaction vessel wells 4 in which the reaction vessel 10 is actually housed with the position of each of the reaction vessel wells 4 for which the measurement conditions have been set, and to determine whether the reaction vessel 10 is correctly housed in each of the reaction vessel wells 4. Further, the reaction vessel housing position determination part 26 is configured in such a way that, when the reaction vessel housing position determination part 26 determines that the reaction vessel 10 is not correctly housed in each of the reaction vessel wells 4 as a result of comparison, the reaction vessel housing position determination part 26 issues a warning to a user, for example, by displaying this fact on the display 28.

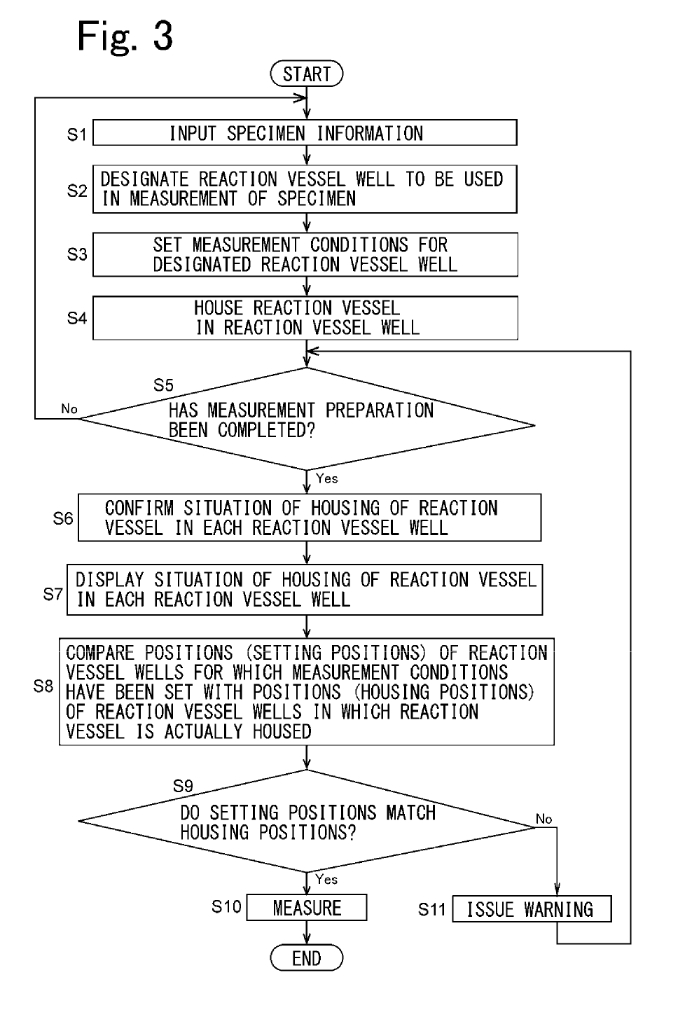

An example of a flow before the measurement of a specimen in the gene measurement apparatus in the embodiment is described next with reference to the flowchart of FIG. 3 together with FIG. 2.

The measurement conditions setting part 24 causes a user to input information relating to a specimen to be measured (step S1) and to designate a reaction vessel well 4 to be used in the measurement of the specimen (step S2). Further, the measurement conditions setting part 24 causes the user to input measurement conditions such as analysis to be performed on the specimen, and sets the input measurement conditions to be measurement conditions for the designated reaction vessel well 4 (step S3). An input of the information relating to the specimen (step S1) is not mandatory, and does not always need to be performed.

After the measurement conditions have been set, the user houses a reaction vessel 10 in which a target specimen is housed in the designated reaction vessel well 4 under the measurement conditions (step S4). Measurement preparation is completed by performing the operations of steps S1 to S4 described above on all of the reaction vessels 10 in which a specimen to be measured is housed (step S5).

When the measurement preparation is completed, the user performs some operation indicating the completion of the measurement preparation. Examples of the operation indicating the completion of the measurement preparation include an operation to input this fact to the arithmetic processor 18 and an operation to close a cover (not illustrated) that covers an upper portion of the temperature control block 2. When the user performs the operation described above, the reaction vessel detector 20 recognizes the completion of the measurement preparation, and confirms a situation of the housing of the reaction vessel 10 in each of the reaction vessel wells 4 by using the optical sensor 14 of the measurement part 12 (step S6). Information relating to the position of each of the reaction vessel wells 4 in which the reaction vessel 10 is housed, as described in FIG. 5, is displayed on the display 28 (step S7).

At this time, by displaying, on the display 28, information for visually distinguishing reaction vessel wells 4 for which the measurement conditions have been set from reaction vessel wells 4 for which the measurement conditions have not been set, as illustrated in FIG. 4, together with the information relating to the position of each of the reaction vessel wells 4 in which the reaction vessel 10 is housed, the user can easily confirm whether each of the reaction vessels 10 is housed in a reaction vessel well 4 located in a correct position.

Then, the reaction vessel housing position determination part 26 compares the positions (setting positions) of reaction vessel wells 4 for which the measurement conditions have been set with the positions (housing positions) of reaction vessel wells 4 in which the reaction vessels 10 are actually housed (step S8), and determines whether the setting positions match the housing positions (step S9). When the setting positions match the housing positions, the reaction vessel housing position determination part 26 determines that the gene measurement apparatus is in a measurable state, and measurement is started according to a command to start measurement from the user (step S10).

When the setting positions do not match the housing positions, the reaction vessel housing position determination part 26 determines that the reaction vessels 10 are housed in incorrect housing positions, and issues a warning to the user, for example, by displaying this fact on the display 28 (step S11). Upon receipt of the warning, the user confirms the housing positions of the reaction vessels 10, houses the reaction vessels 10 in correct positions, and performs the operation indicating the completion of the measurement preparation again (step S5). The reaction vessel detector 20 reconfirms a situation of the housing of the reaction vessel 10 in each of the reaction vessel wells 4 (step S6), and information relating to the position of each of the reaction vessel wells 4 in which the reaction vessel 10 is housed is displayed on the display 28 (step S7). The reaction vessel housing position determination part 26 compares the setting positions with the housing positions again (step S8), and determines whether the setting positions match the housing positions (step S9).

The description above of the flow has been made under the assumption that, after measurement conditions for a specimen are set, a reaction vessel 10 in which the specimen is housed is housed in a designated reaction vessel well 4. However, a reaction vessel 10 may be housed in advance in an arbitrary reaction vessel well 4, and measurement conditions may be set for the reaction vessel well 4 in which the reaction vessel 10 is housed. The same flow of steps S5 to S11 is applied to this case.

What is claimed is:

1. A gene measurement apparatus comprising:
a temperature control block that is provided with a plurality of reaction vessel wells on an upper surface of the temperature control block, each of the plurality of reaction vessel wells being used to house a reaction vessel, and that performs temperature treatment on a specimen in the reaction vessel by controlling temperature of the plurality of reaction vessel wells using a heating element or a cooling element; and
a reaction vessel detector configured to detect whether the reaction vessel is housed in each of the plurality of reaction vessel wells of the temperature control block before the temperature treatment is started.

2. The gene measurement apparatus according to claim 1, further comprising an optical sensor that performs optical detection on each of the plurality of reaction vessel wells,
wherein the reaction vessel detector is configured to determine whether the reaction vessel is housed in each of the plurality of reaction vessel wells in accordance with a detection signal of the optical sensor with respect to each of the plurality of reaction vessel wells.

3. The gene measurement apparatus according to claim 1, further comprising:
a display that displays information; and
a reaction vessel housing position display configured to display, on the display, a position of a reaction vessel well in which the reaction vessel detector has detected that the reaction vessel is housed, before the temperature treatment is started.

4. The gene measurement apparatus according to claims 1, further comprising:
a measurement conditions setting part configured to cause a user to set measurement conditions for an arbitrary reaction vessel well of the plurality of reaction vessel wells; and
a reaction vessel position determination part that determines whether a position of the arbitrary reaction vessel well for which the measurement conditions have been set by the measurement conditions setting part matches the position of the reaction vessel well in which the reaction vessel detector has detected that the reaction vessel is housed, before the temperature treatment is started.

5. The gene measurement apparatus according to claim 4, wherein the reaction vessel position determination part is configured to issue a warning to the user, when the position of the arbitrary reaction vessel well for which the measurement conditions have been set by the measurement conditions setting part does not match the position of the reaction vessel well in which the reaction vessel detector has detected that the reaction vessel is housed.
